(19) United States
(12) Patent Application Publication
(10) Pub. No.: US 2021/0048162 A1
(43) Pub. Date: Feb. 18, 2021

(54) HEADLAMP FOR VEHICLE AND METHOD FOR CONTROLLING THE SAME

(71) Applicant: HYUNDAI MOBIS Co., Ltd., Seoul (KR)

(72) Inventors: Sung Hwan JO, Yongin-si (KR); In Sub MOON, Yongin-si (KR); Yoo Pyo HONG, Yongin-si (KR); Jun Hee MUN, Yongin-si (KR)

(21) Appl. No.: 16/991,444

(22) Filed: Aug. 12, 2020

(30) Foreign Application Priority Data
Aug. 13, 2019 (KR) 10-2019-0098556

(51) Int. Cl. F21S 41/43; F21S 43/241

(52) U.S. Cl. CPC F21S 41/43; F21W 2107/10; F21S 43/241

(57) ABSTRACT

A headlamp for a vehicle may include: a left inner high beam source having a plurality of left inner high beam elements arranged therein, and configured to emit a left inner high beam; a left outer high beam source having a plurality of left outer high beam elements arranged therein, and configured to emit a left outer high beam to overlap the left inner high beam emitted from the left inner high beam source; a right inner high beam source having a plurality of right inner high beam elements arranged therein, and configured to emit a right inner high beam; and a right outer high beam source having a plurality of right outer high beam elements arranged therein, and configured to emit a right outer high beam to overlap the right inner high beam emitted from the right inner high beam source.

### CROSS-REFERENCE TO RELATED APPLICATION

This application claims priority from and the benefit of Korean Patent Application No. 10-2019-0098556, filed on Aug. 13, 2019, which is hereby incorporated by reference for all purposes as if set forth herein.

### BACKGROUND

### Field

Exemplary embodiments of the present disclosure relate to a headlamp for a vehicle and a method for controlling the same, and more particularly, to a headlamp for a vehicle, which can reduce the installation number of high beam elements, and secure a necessary luminous intensity, and a method for controlling the same.

### DISCUSSION OF THE BACKGROUND

In general, a headlamp is installed on either side of the front of a vehicle. The headlamp includes a low beam source and a high beam source. The low beam source has a plurality of low beam elements arranged therein, and the high beam source has a plurality of high beam elements arranged therein. The headlamp is interconnected to a camera unit, and controlled to partially turn on a high beam, when an oncoming vehicle or forward vehicle is detected ahead of an ego vehicle. As the high beam is partially turned on, it is possible to secure the visibility of a driver in the ego vehicle while preventing glare of a driver in the oncoming vehicle or forward vehicle.

In the related art, however, the installation number of high beam elements is increased in order to raise the luminous intensities of the high beam elements except the high beam elements to form a darkness area, while securing the resolution of the headlamp. Thus, the manufacturing cost of the vehicle may be increased.

Therefore, there is a need for a device capable of solving the problem.

The related art of the present disclosure is disclosed in Korean Patent Application No. 2013-0009324 published on Jan. 23, 2013 and entitled “LED Headlamp”.

The above information disclosed in this Background section is only for enhancement of understanding of the background of the invention and, therefore, it may contain information that does not constitute prior art.

### SUMMARY

Exemplary embodiments of the present invention provide a headlamp for a vehicle, which can reduce the installation number of high beam elements, and secure a necessary luminous intensity, and a method for controlling the same.

In an embodiment, a headlamp for a vehicle may include: a left inner high beam source having a plurality of left inner high beam elements arranged therein, and configured to emit a left inner high beam; a left outer high beam source having a plurality of left outer high beam elements arranged therein, and configured to emit a left outer high beam to overlap the left inner high beam emitted from the left inner high beam source; a right inner high beam source having a plurality of right inner high beam elements arranged therein, and configured to emit a right inner high beam; and a right outer high beam source having a plurality of right outer high beam elements arranged therein, and configured to emit a right outer high beam to overlap the right inner high beam emitted from the right inner high beam source.

The left inner high beams emitted from the one or more left inner high beam elements may overlap the right inner high beams emitted from the one or more right inner high beam elements.

The plurality of left inner high beam elements may emit the left inner high beams to overlap each other, and the plurality of right inner high beam elements may emit the right inner high beams to overlap each other.

The plurality of left outer high beam elements may emit the left outer high beams to overlap each other, and the plurality of right outer high beam elements may emit the right outer high beams to overlap each other.

When some high beam elements among the plurality of left inner high beam elements, the plurality of left outer high beam elements, the plurality of right inner high beam elements and the plurality of right outer high beam elements are turned off, the amount of current supplied to the high beam elements which are turned on, among the plurality of left inner high beam elements, the plurality of left outer high beam elements, the plurality of right inner high beam elements and the plurality of right outer high beam elements, may be increased.

The amount of current supplied to some left outer high beam elements disposed at an edge may be increased, and the amount of current supplied to some right outer high beam elements disposed at an edge may be increased.

In an embodiment, a method for controlling a headlamp for a vehicle may include: emitting, by a left inner high beam source, a left inner high beam and emitting, by a left outer high beam source, a left outer high beam such that the left inner high beam and the left outer high beam overlap each other; and emitting, by a right inner high beam source, a right inner high beam and emitting, by a right outer high beam source, a right outer high beam such that the right inner high beam and the right outer high beam overlap each other.

The left inner high beams emitted from one or more left inner high beam elements may overlap the right inner high beams emitted from one or more right inner high beam elements.

The plurality of left inner high beam elements may emit the left inner high beams to overlap each other, and the plurality of right inner high beam elements may emit the right inner high beams to overlap each other.

The plurality of left outer high beam elements may emit the left outer high beams to overlap each other, and the plurality of right outer high beam elements may emit the right outer high beams to overlap each other.

When some high beam elements among the plurality of left inner high beam elements, the plurality of left outer high beam elements, the plurality of right inner high beam elements and the plurality of right outer high beam elements are turned off, the amount of current supplied to the high beam elements which are turned on, among the plurality of left inner high beam elements, the plurality of left outer high beam elements, the plurality of right inner high beam elements and the plurality of right outer high beam elements, may be increased.

The amount of current supplied to some left outer high beam elements disposed at an edge may be increased, and the amount of current supplied to some right outer high beam elements disposed at an edge may be increased.

In accordance with the present embodiment, since the left inner high beam and the left outer high beam are emitted to overlap each other and the right inner high beam and the right outer high beam are emitted to overlap each other, it is possible to sufficiently secure a necessary luminous intensity while increasing the resolutions of the left high beam and the right high beam.

Furthermore, since the widths of the patterns of the left inner high beam, the left outer high beam, the right inner high beam and the right outer high beam are increased, the installation number of high beam elements can be reduced.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a configuration diagram illustrating a headlamp for a vehicle in accordance with an embodiment of the present disclosure.

FIG. 2 is a configuration diagram illustrating that a high beam is emitted from the headlamp for a vehicle in accordance with the embodiment of the present disclosure.

FIG. 3 is a configuration diagram illustrating that, when an oncoming vehicle or forward vehicle is detected, a darkness area is formed as corresponding high beam elements are turned off in the headlamp for a vehicle in accordance with the embodiment of the present disclosure.

FIG. 4 is a flowchart illustrating a method for controlling a headlamp for a vehicle in accordance with an embodiment of the present disclosure.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

Hereinafter, a headlamp for a vehicle and a method for controlling the same will be described below with reference to the accompanying drawings through various exemplary embodiments. It should be noted that the drawings are not to precise scale and may be exaggerated in thickness of lines or sizes of components for descriptive convenience and clarity only. Furthermore, the terms as used herein are defined by taking functions of the invention into account and can be changed according to the custom or intention of users or operators. Therefore, definition of the terms should be made according to the overall disclosures set forth herein.

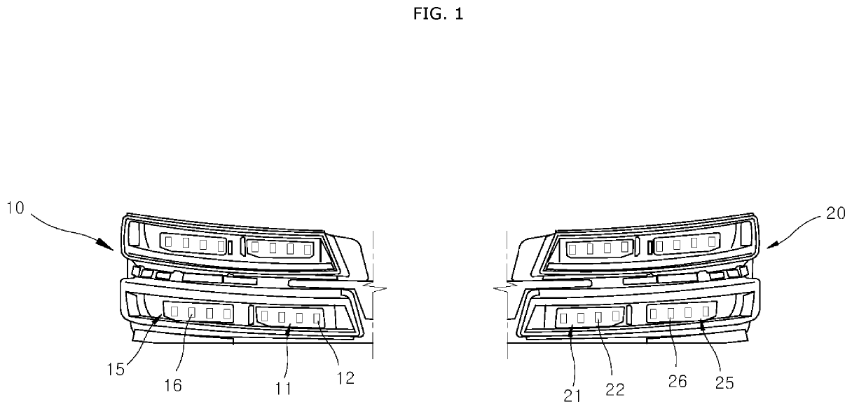

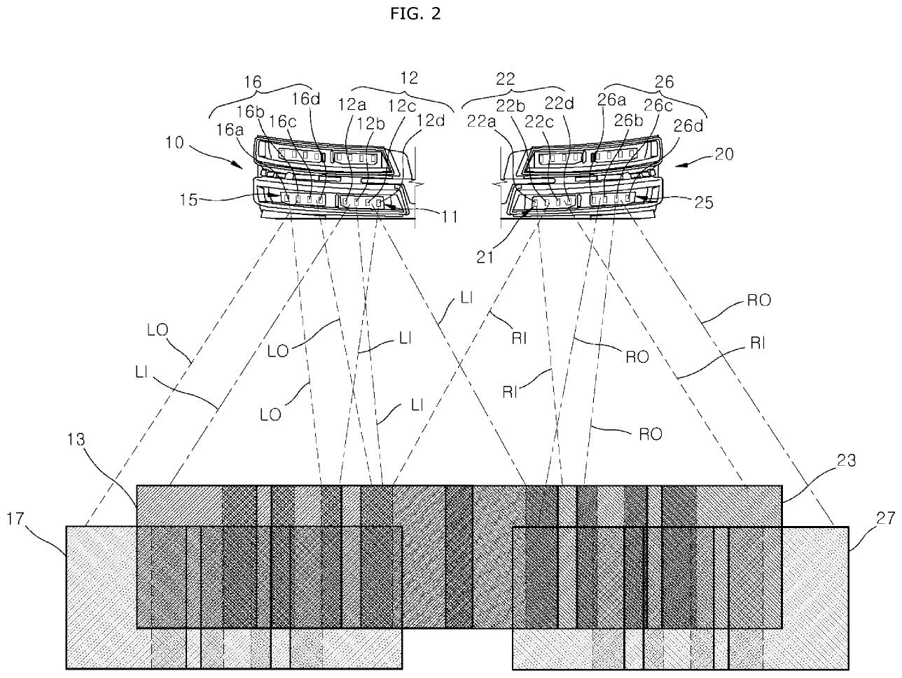

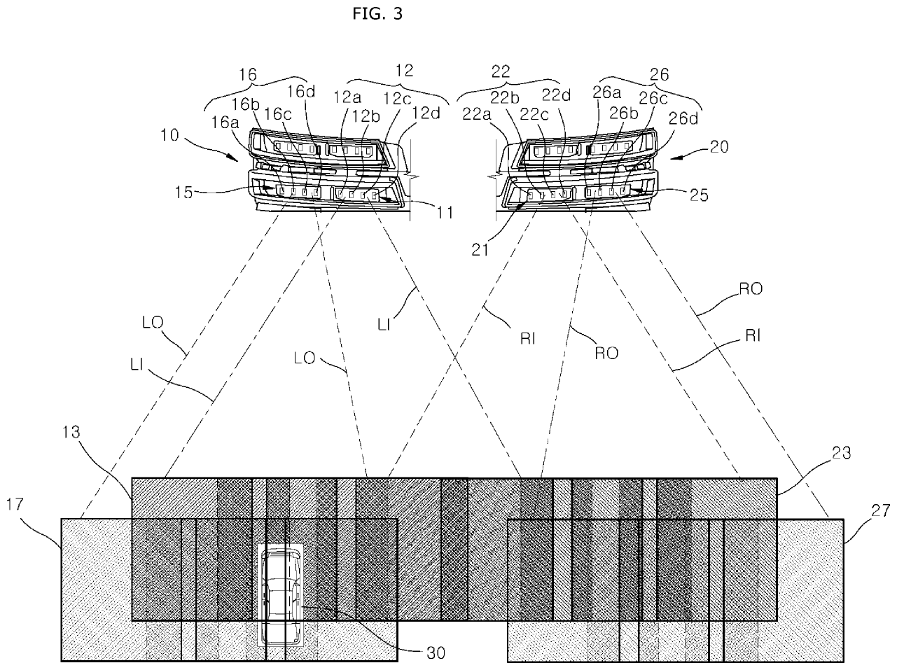

FIG. 1 is a configuration diagram illustrating a headlamp for a vehicle in accordance with an embodiment of the present disclosure, FIG. 2 is a configuration diagram illustrating that a high beam is emitted from the headlamp for a vehicle in accordance with the embodiment of the present disclosure, and FIG. 3 is a configuration diagram illustrating that, when an oncoming vehicle or forward vehicle is detected, a darkness area is formed as corresponding high beam elements are turned off in the headlamp for a vehicle in accordance with the embodiment of the present disclosure.

Referring to FIGS. 1 to 3, the headlamp for a vehicle in accordance with the embodiment of the present disclosure includes a left inner high beam source 11, a left outer high beam source 15, a right inner high beam source 21 and a right outer high beam source 25.

The vehicle includes a left headlamp 10 and a right headlamp 20 which are installed thereon. The left inner high beam source 11 and the left outer high beam source 15 are disposed in the left headlamp 10. The right inner high beam source 21 and the right outer high beam source 25 are disposed in the right headlamp 20.

The left inner high beam source 11 has a plurality of left inner high beam elements 12 that include 12a, 12b, 12c, and 12d arranged therein to emit a left inner high beam LI. The left inner high beam elements 12 may be arranged in one or more lines in a horizontal direction.

Each of the left inner high beam source 11, the left outer high beam source 15, the right inner high beam source 21 and the right outer high beam source 25 includes an optical lens part (not illustrated) to control the emission shape of a high beam.

The left outer high beam source 15 has a plurality of left outer high beam elements 16 that include 16a, 16b, 16c, and 16d arranged therein, and emits a left outer high beam LO to overlap the left inner high beam LI emitted by the left inner high beam source 11. The left outer high beam elements 16 may be arranged in one or more lines in a horizontal direction. In FIG. 2, the beam pattern of the left inner high beam LI is represented by 13, and the beam pattern of the left outer high beam LO is represented by 17.

The right inner high beam source 21 has a plurality of right inner high beam elements 22 that include 22a, 22b, 22c, and 22d arranged therein to emit a right inner high beam RI. The right inner high beam elements 22 may be arranged in one or more lines in the horizontal direction.

The right outer high beam source 25 has a plurality of right outer high beam elements 26 that include 26a, 26b, 26c, and 26d arranged therein, and emits a right outer high beam RO to overlap the right inner high beam RI emitted by the right inner high beam source 21. The right outer high beam elements 26 may be arranged in one or more lines in the horizontal direction. In FIG. 2, the beam pattern of the right inner high beam RI is represented by 23, and the beam pattern of the right outer high beam RO is represented by 27.

Because the left inner high beam LI and the left outer high beam LO are emitted to overlap each other and the right inner high beam RI and the right outer high beam RO are emitted to overlap each other, it is possible to sufficiently secure a necessary luminous intensity while increasing the resolutions of the left high beam and the right high beam.

Because the widths of the beam patterns 13, 17, 23 and 27 of the left inner high beam LI, the left outer high beam LO, the right inner high beam RI and the right outer high beam RO are increased, it is possible to reduce the installation number of high beam elements. For example, 26 to 32 high beam elements are installed in the related art. However, although about 16 high beam elements are installed in each of the left headlamp 10 and the right headlamp 20 in accordance with the embodiment of the present disclosure, a sufficient luminous intensity can be secured.

The left inner high beams LI emitted from one or more left inner high beam elements 12 overlaps the right inner high beams RI emitted from one or more right inner high beam elements 22. Therefore, because the left inner high beam LI and the right inner high beam RI overlap each other in the center of the forward area of the vehicle, the luminous intensity of the high beam emitted to the center of the forward area of the vehicle may be increased.

The plurality of left inner high beam elements 12 emit the left inner high beams LI to overlap each other, and the plurality of right inner high beam elements 22 emit the right inner high beams RI to overlap each other. Therefore, the luminous intensity of the left inner high beams LI and the luminous intensity of the right inner high beams RI may be increased.

The plurality of left outer high beam elements 16 emit the left outer high beams LO to overlap each other, and the plurality of right outer high beam elements 26 emit the right outer high beams RO to overlap each other. Therefore, the luminous intensity of the left outer high beams LO and the luminous intensity of the right outer high beams RO may be increased.

The left inner high beams LI may be emitted to overlap each other, the right inner high beams RI may be emitted to overlap each other, the left outer high beams LO may be emitted to overlap each other, and the right outer high beams RO may be emitted to overlap each other.

When a control unit reads an image inputted through a camera unit and detects an oncoming vehicle or forward vehicle ahead of the ego vehicle, the control unit may turn off some high beam elements which emit high beams to the oncoming vehicle or forward vehicle, among the plurality of left inner high beam elements 12, the plurality of left outer high beam elements 16, the plurality of right inner high beam elements 22 and the plurality of right outer high beam elements 26. In this case, the control unit increases the amount of current supplied to high beam elements, which are turned on among the plurality of left inner high beam elements 12, the plurality of left outer high beam elements 16, the plurality of right inner high beam elements 22 and the plurality of right outer high beam elements 26. Therefore, because a darkness area 30 is formed where the oncoming vehicle or forward vehicle is located, it is possible to turn off high beam elements directed at an oncoming driver and prevent glare to a driver in the oncoming vehicle or forward vehicle. Furthermore, because the luminous intensity is increased in a light area (not illustrated) except the area where the darkness area 30 is formed, the visibility of the driver can be secured.

At this time when some high beam elements are turned off, the amount of current supplied to some left outer high beam elements 16a and 16b disposed at the edge may be increased, and the amount of current supplied to some right outer high beam elements 26c and 26d disposed at the edge may be increased, but embodiments are not limited thereto.

Depending on the placement of the darkness area 30, the camera unit may detect a location of the vehicle and the control unit may select combinations of high beam elements to be turned off and turned on as an opposing vehicle approaches. When some high beam areas are turned off to reduce glare to an oncoming driver, current is increased to other high beam elements to increase a visibility of the ego vehicle.

Therefore, although the overlap between the high beams at the edges of the left high beam section and the right high beam section, or selective beams, is relatively reduced, the supply of the current may be increased to raise the luminous intensity at remaining turned on high beams such as both edges (side areas) of the vehicle, which makes it possible to secure the visibility of the driver.

Hereafter, a method for controlling a headlamp for a vehicle in accordance with an embodiment of the present disclosure, which is configured as described above, will be described.

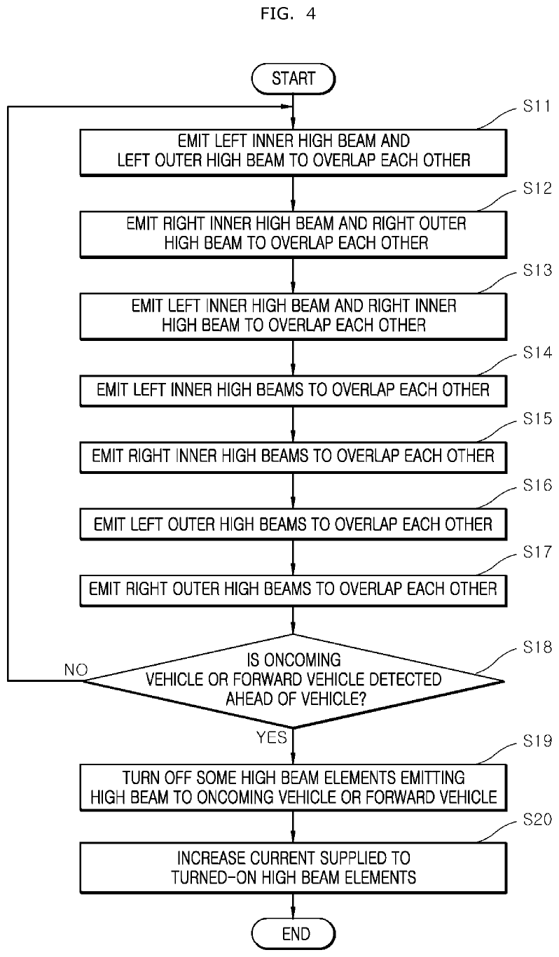

FIG. 4 is a flowchart illustrating a method for controlling a headlamp for a vehicle in accordance with an embodiment of the present disclosure.

Referring to FIG. 4, the left inner high beam source 11 and the left outer high beam source 15 emit the left inner high beam LI and the left outer high beam LO to overlap each other in step S11. Furthermore, the right inner high beam source 21 and the right outer high beam source 25 emit the right inner high beam RI and the right outer high beam RO to overlap each other in step S12.

Because the left inner high beam LI and the left outer high beam LO are emitted to overlap each other and the right inner high beam RI and the right outer high beam RO are emitted to overlap each other, it is possible to sufficiently secure a necessary luminous intensity while increasing the resolutions of the left high beam and the right high beam. Furthermore, because the widths of the beam patterns 13, 17, 23 and 27 of the left high beam and the right high beam can be increased, it is possible to reduce the installation number of high beam elements.

One or more left inner high beam elements 12 and one or more right inner high beam elements 22 emit the left inner high beams LI and the right inner high beams RI to overlap each other in step S13. Therefore, because the left inner high beam LI and the right inner high beam RI overlap each other in the center of the forward area of the vehicle, the luminous intensity of the high beam emitted to the center of the forward area of the vehicle may be increased.

The plurality of left inner high beam elements 12 emit the left inner high beams LI to overlap each other, and the plurality of right inner high beam elements 22 emit the right inner high beams RI to overlap each other, in steps S14 and S15, respectively. Therefore, the luminous intensity of the left inner high beam LI and the luminous intensity of the right inner high beam RI may be increased.

The plurality of left outer high beam elements 16 emit the left outer high beams LO to overlap each other, and the plurality of right outer high beam elements 26 emit the right outer high beams RO to overlap each other, in steps S16 and S17, respectively. Therefore, the luminous intensities of the left outer high beams LO and the right outer high beams RO may be increased.

The control unit (not illustrated) reads an image inputted through the camera unit (not illustrated), and determines whether an oncoming vehicle or forward vehicle is detected ahead of the ego vehicle, in step S18.

When the oncoming vehicle or forward vehicle is detected ahead of the ego vehicle, the control unit may turn off some high beam elements which emit high beams to the oncoming vehicle or forward vehicle, among the plurality of left inner high beam elements 12, the plurality of left outer high beam elements 16, the plurality of right inner high beam elements 22 and the plurality of right outer high beam elements 26, in step S19. In this case, the control unit increases the amount of current supplied to high beam elements which are turned on among the plurality of left inner high beam elements 12, the plurality of left outer high beam elements 16, the plurality of right inner high beam elements 22 and the plurality of right outer high beam elements 26, in step S20.

Therefore, because the darkness area 30 is formed where the oncoming vehicle or forward vehicle is located, it is possible to prevent glare of a driver in the oncoming vehicle or forward vehicle. Furthermore, because the luminous intensity is increased in a light area except the area where the darkness area 30 is formed, the visibility of the driver can be secured.

At this time, the amount of current supplied to some left outer high beam elements 16 disposed at the edge may be increased, and the amount of current supplied to some right outer high beam elements 26 disposed at the edge may be increased. Therefore, although the overlap between the high beams at the edges of the left high beam section and the right high beam section is relatively reduced, the supply of the current may be increased to raise the luminous intensity at both side areas of the vehicle.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. A headlamp for a vehicle, comprising:
a left inner high beam source having a plurality of left inner high beam elements arranged therein, and configured to emit a left inner high beam;
a left outer high beam source having a plurality of left outer high beam elements arranged therein, and configured to emit a left outer high beam to overlap the left inner high beam emitted from the left inner high beam source;
a right inner high beam source having a plurality of right inner high beam elements arranged therein, and configured to emit a right inner high beam; and
a right outer high beam source having a plurality of right outer high beam elements arranged therein, and configured to emit a right outer high beam to overlap the right inner high beam emitted from the right inner high beam source.

2. The headlamp of claim 1, wherein the left inner high beams emitted from the one or more left inner high beam elements overlap the right inner high beams emitted from the one or more right inner high beam elements.

3. The headlamp of claim 1, wherein the plurality of left inner high beam elements emit the left inner high beams to overlap each other, and
the plurality of right inner high beam elements emit the right inner high beams to overlap each other.

4. The headlamp of claim 1, wherein the plurality of left outer high beam elements emit the left outer high beams to overlap each other, and
the plurality of right outer high beam elements emit the right outer high beams to overlap each other.

5. The headlamp of claim 1, wherein when some high beam elements among the plurality of left inner high beam elements, the plurality of left outer high beam elements, the plurality of right inner high beam elements and the plurality of right outer high beam elements are turned off, the amount of current supplied to the high beam elements which are turned on, among the plurality of left inner high beam elements, the plurality of left outer high beam elements, the plurality of right inner high beam elements and the plurality of right outer high beam elements, is increased.

6. The headlamp of claim 5, wherein the amount of current supplied to some left outer high beam elements disposed at an edge is increased, and
the amount of current supplied to some right outer high beam elements disposed at an edge is increased.

7. A method for controlling a headlamp for a vehicle, comprising:
emitting, by a left inner high beam source, a left inner high beam and emitting, by a left outer high beam source, a left outer high beam such that the left inner high beam and the left outer high beam overlap each other; and
emitting, by a right inner high beam source, a right inner high beam and emitting, by a right outer high beam source, a right outer high beam such that the right inner high beam and the right outer high beam overlap each other.

8. The method of claim 7, wherein the left inner high beams emitted from one or more left inner high beam elements overlap the right inner high beams emitted from one or more right inner high beam elements.

9. The method of claim 7, wherein a plurality of left inner high beam elements emit the left inner high beams to overlap each other, and
a plurality of right inner high beam elements emit the right inner high beams to overlap each other.

10. The method of claim 7, wherein a plurality of left outer high beam elements emit the left outer high beams to overlap each other, and
a plurality of right outer high beam elements emit the right outer high beams to overlap each other.

11. The method of claim 7, wherein when some high beam elements among the plurality of left inner high beam elements, the plurality of left outer high beam elements, the plurality of right inner high beam elements and the plurality of right outer high beam elements are turned off, the amount of current supplied to the high beam elements which are turned on, among the plurality of left inner high beam elements, the plurality of left outer high beam elements, the plurality of right inner high beam elements and the plurality of right outer high beam elements, is increased.

12. The method of claim 11, wherein the amount of current supplied to some left outer high beam elements disposed at an edge is increased, and
the amount of current supplied to some right outer high beam elements disposed at an edge is increased.

13. A headlamp system, comprising:
a left headlamp unit including a plurality of left inner high beam elements and left outer high beam elements;
a right headlamp unit including a plurality of right inner high beam elements and right outer high beam elements;
a camera unit configured to detect oncoming traffic patterns; and
a control unit configured to detect a location of an oncoming vehicle from the camera unit and turn off at least one of the left inner high beam elements, left outer high beam elements, right inner high beam elements, and right outer high beam elements while increasing current to high beam elements that remain on.

14. The headlamp of claim 13, wherein left inner high beams emitted from one of more left inner high beam elements overlap right inner high beams emitted from one or more right inner high beam elements.

15. The headlamp of claim 13, wherein the plurality of left inner high beam elements emit left inner high beams to overlap each other, and
the plurality of right inner high beam elements emit right inner high beams to overlap each other.

16. The headlamp of claim 13, wherein the plurality of left outer high beam elements emit left outer high beams to overlap each other, and
the plurality of right outer high beam elements emit right outer high beams to overlap each other.

17. The headlamp of claim 13, wherein an amount of current supplied to some left outer high beam elements disposed at an edge is increased and the amount of current supplied to some right outer high beam elements disposed at an edge is increased.
